(19) United States
(12) Patent Application Publication
(10) Pub. No.: US 2022/0348088 A1
(43) Pub. Date: Nov. 3, 2022

(54) Solar Windmill Car

(71) Applicant: Alice Jane Gage, Dearborn, MI (US)

(72) Inventor: Alice Jane Gage, Dearborn, MI (US)

(21) Appl. No.: 17/463,974

(22) Filed: Sep. 1, 2021

Related U.S. Application Data
(63) Continuation-in-part of application No. 29/778,661, filed on Apr. 29, 2021.

(51) Int. Cl. B60L 8/00; B60L 53/20

(52) U.S. Cl. CPC B60L 8/003; B60L 8/006; B60L 53/20; B60L 2210/10

(57) ABSTRACT

A solar and wind powered vehicle for use with an all electric or hybrid electric vehicle. The solar and wind vehicle comprises a plurality of solar panels arranged on an outside surface of the vehicle and a wind turbine mounted to a surface of the vehicle. Both the plurality of solar panels and wind turbine are electrically connected to the battery pack of the vehicle and charge the battery pack when the sun and wind activate the solar panels and wind turbine.

This application is a continuation-in-part of U.S. patent application Ser. No. 29/778,661 filed Apr. 29, 2021

### BACKGROUND OF THE INVENTION

### 1. Field of the Invention

The present invention generally relates to electric vehicles and more particularly relates to an electric vehicle that uses solar panels and a windmill to help charge the battery pack arranged thereon.

### 2. Description of Related Art

Electric cars have become common place in the market and are well known in the art. Electric cars may either be all electric vehicles, which rely totally on battery power to propel the vehicle or a hybrid vehicle that also includes a gasoline engine used in conjunction with a battery pack in order to increase the gas mileage of the hybrid vehicle. Most of the prior art electric vehicles have to be charged overnight and may take up to fifteen hours to completely charge the battery pack arranged thereon. The hybrid vehicle allows for an internal combustion engine to take over propelling the vehicle when the battery pack of the hybrid vehicle has been drained or depleted. The use of all electric vehicles or hybrid vehicles does reduce emissions into the atmosphere and provides for better fuel economy for an original equipment manufacturer (OEM), such as Ford, GM, Chrysler, etc. creating such cars.

However, the battery operated cars also run into problems when operated in cold weather, if the battery pack has a heating issue or if the vehicle was parked overnight in an area where a charging platform was not available to recharge the vehicle. Such issues may occur for the owner of an all electric vehicle versus that of an internal combustion engine. Therefore, there appears to be a problem in the art with creating an electric vehicle that has an extended range and a charge time similar to that of the time needed to fill a gas tank of an internal combustion engine vehicle. Furthermore, there is a problem in the art of having enough time to fully charge a battery pack of an electric vehicle in order to get the greatest range from that electric vehicle. Furthermore, there is a problem with having an electric grid that is capable of completely charging a battery pack of a modern day vehicle.

Therefore, there is a need in the art for an improved electric or hybrid vehicle. There also is a need in the art for an electric vehicle that has an outer shell made with solar panels to assist in charging and maintaining the charge of a battery pack arranged thereon. There also is a need in the art for the use of a windmill, which forms a wind electric system attached to a surface of an electric vehicle in order to assist in charging and maintaining the charge in the battery pack of that vehicle. There also is a need in the art for systems that allow for the charging of the battery pack or the maintaining of the charge thereon without the need for attaching to the electrical grid of the location of the electric vehicle.

### SUMMARY OF THE INVENTION

One object of the present invention may be to provide a novel and unique all electric or hybrid vehicle.

Another object of the present invention may be to provide an electric vehicle that has a plurality of solar panels arranged on the outer shell thereof.

Still another object of the present invention may be to provide an electric vehicle that has a windmill arranged on a surface of the vehicle.

Still another object of the present invention may be to provide an electric vehicle that is capable of charging the battery pack arranged thereon via either the sun or wind.

Still another object of the present invention may be to provide an electric vehicle that uses a combination of solar panels and a windmill electric system to help charge or maintain the charge of a battery pack thereof.

Still another object of the present invention may be to provide an electric vehicle that when the vehicle is not driving it is still capable of using solar panels and a windmill turbine to store energy in the battery pack arranged thereon.

According to the present invention, the foregoing and other objects and advantages are obtained by a novel design for a solar windmill vehicle. The solar windmill powered vehicle comprises a plurality of solar panels arranged on an outside surface of the vehicle and a wind turbine mounted to a surface of the vehicle. Both the solar panels and wind turbine are connected to a battery pack and help to charge the battery pack or maintain a charge thereon, thus increasing the driving distance of the electric vehicle and also reducing the amount of time necessary to recharge the battery pack to a full charge.

One advantage of the present invention may be that it provides a novel and unique all electric or hybrid vehicle.

Another advantage of the present invention may be that it provides for an electric vehicle that has a plurality of solar panels arranged on an outer surface thereof.

Still another advantage of the present invention may be that it provides for an electric vehicle that has a windmill arranged on an outer surface thereof, thus providing a wind electric system for the electric vehicle.

Still another advantage of the present invention may be that it provides an electric vehicle that uses the solar panels and windmill to charge the onboard battery pack or maintain the charge of the onboard battery pack.

Still another advantage of the present invention may be that it provides an electric vehicle that uses a plurality of solar panels in conjunction with a windmill to assist in charging and maintaining the charge of a battery pack arranged thereon.

Still another advantage of the present invention may be that it provides an electric vehicle that when the vehicle is driving or not driving, the solar panels and windmill are still charging the battery pack arranged thereon.

Yet another advantage of the present invention may be that it provides an electric vehicle that has increased range and reduce time for a full charge via the use of solar panels and the windmill systems.

Still another advantage of the present invention may be that it provides an electric vehicle that when the vehicle is moving a turbine blade is turning and creating energy, wherein if that energy is greater then what a battery is supplying, the battery may be turned off and the vehicle's energy needs may be supplied by the wind turbine only.

Other objects, features and advantages of the present invention will become apparent from the subsequent description, and appended claims taken in conjunction with the accompanying drawings.

### BRIEF DESCRIPTION OF THE DRAWINGS

FIG. 1 shows a perspective view of a solar windmill vehicle according to the present invention.

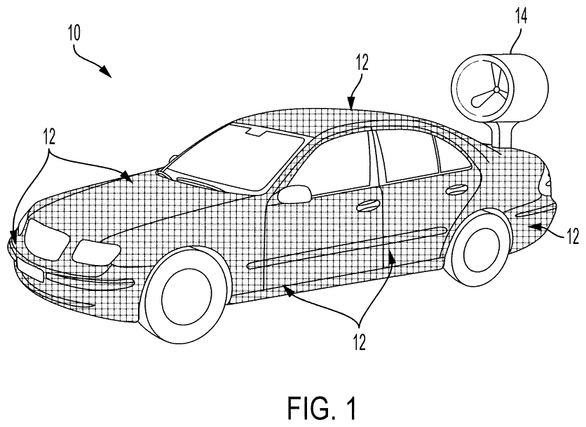

FIG. 2 shows a component view of the solar windmill vehicle according to the present invention.

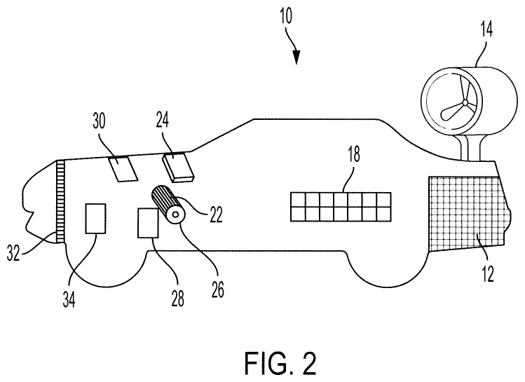

FIG. 3 shows a flow chart of the solar panels for use on a solar windmill vehicle according to the present invention.

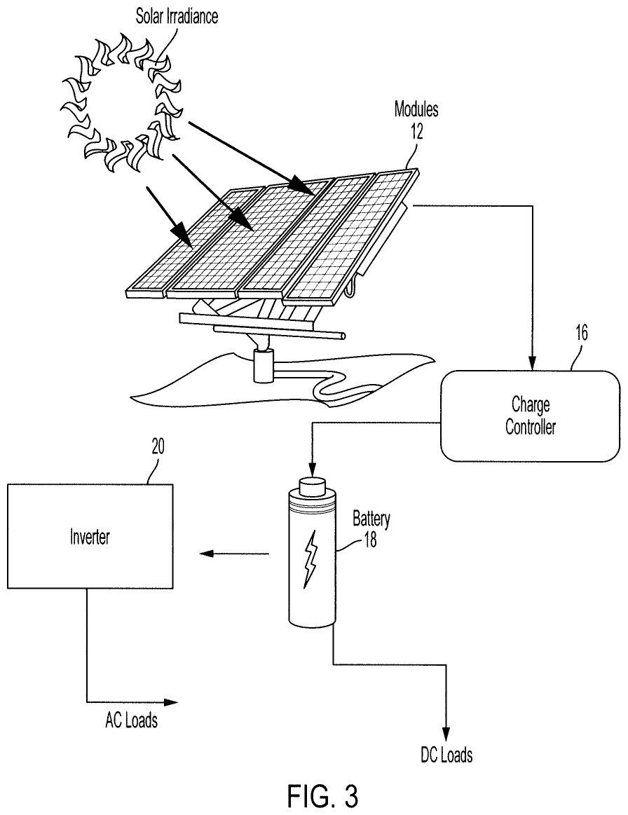

FIG. 4 shows a chart of solar panels for use on a solar windmill vehicle.

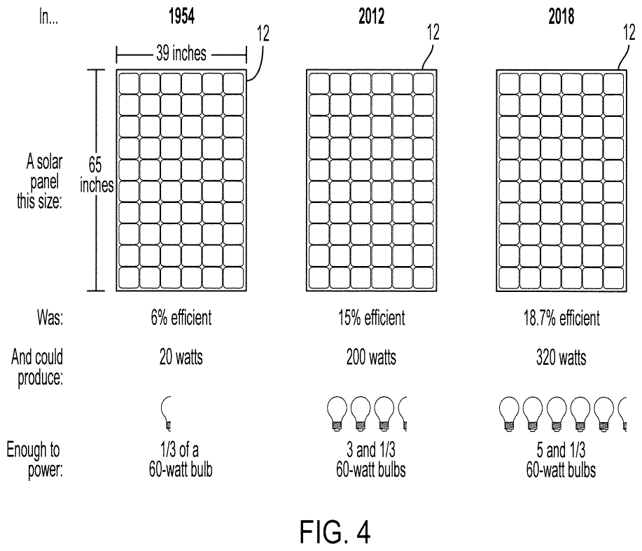

FIG. 5 shows an app logo for use with the methodology of the solar windmill vehicle according to the present invention.

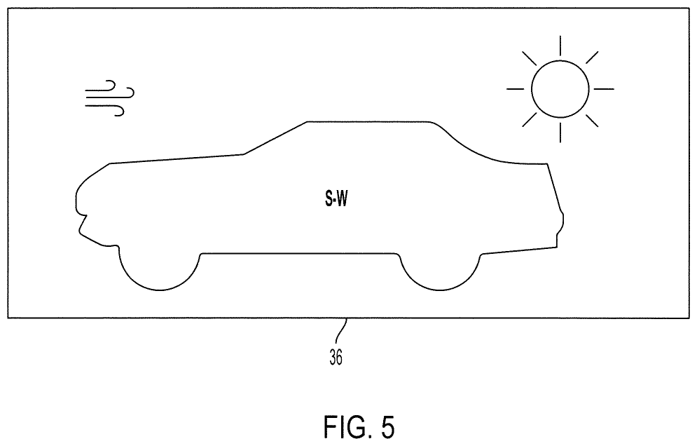

FIG. 6 shows a power level indicator for use with a solar windmill vehicle according to the present invention.

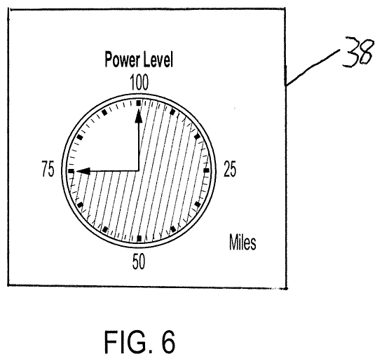

### DESCRIPTION OF THE EMBODIMENT(S)

Referring to the drawings, a solar windmill vehicle or vehicle 10 that is capable of being used on an all electric vehicle or a hybrid electric vehicle is shown. It should be noted that the vehicle 10 may be an all electric vehicle which is powered by a battery pack exclusively or a hybrid electric vehicle which uses a battery pack in combination with an internal combustion engine in order to propel the vehicle 10. It should be noted that any type of vehicle 10, such as but not limited to a car, a boat, a plane, a spacecraft or the like may be used with the solar windmill invention of the present invention. As an example, an original equipment manufacturer (OEM), such as Ford, GM, Chrysler, etc., may select a vehicle for use in having the invention arranged thereon. In one example, a Chevy Volt, which is an all electric vehicle, may be used in combination with a plurality of solar panels 12 of the present invention and/or in conjunction with a windmill turbine or wind electric system 14 associated with the present invention. It should be noted that any known vehicle in the market that uses either a hybrid system, an all electric system or even a complete internal combustion engine system may use the present invention. Generally, the total surface area of all of the exposed panels on the outer surface of the vehicle 10 may be covered in solar panels 12 according to the present invention. The solar panels 12 may be any of the known solar panels 12 and may be flexible solar panels or hard solar panels. The solar panels 12 may be built to withstand the rigors of a moving vehicle from stones, rain, hail and other objects that fly and impact the outer surface of a vehicle. Generally, the manufacturer would determine the total surface area of all of the exposed panels. These panels generally cover the hood, roof, the trunk, the side door panels, the rear door panels, and all quarter panels of the vehicle 10. All of these surfaces on the outer surface of the vehicle 10 would be covered with solar panels 12. It should be noted that a predetermined bottom portion of the quarter panels, the front grill, the front bumper and rear bumper of the vehicle 10 may not have solar panels 12 in one contemplated embodiment. This non solar panel portion is more susceptible to the intrusion of rock, water and other road debris hitting the bottom portion of the vehicle 10. In one contemplated embodiment, the predetermined bottom portion of the panels, grills and bumpers not covered in solar panels would be approximately eight inches, however any other sized area may not be covered. In another contemplated embodiment, the entire vehicle 10 may be completely covered in solar panels 12. Some solar panels 12 may be capable of resisting damage from rock, water and other road debris. After the complete total surface area of all of the sheet metal panels of the vehicle is covered with the solar panels 12, the solar energy that may be generated by such panels 12 may be calculated. In this example, approximately two kilowatts may be generated from the sun interacting with the solar panels 12 on a Chevy Volt. This energy created from the sun via the solar panels 12 may in turn reduce the time required to recharge the Volt's battery pack to a full charge. It should be noted that depending on the amount of sun light and the time between vehicle trips, the battery charging time in this example may be reduced by up to approximately three hours, however a bigger reduction or smaller reduction is also possible with the invention depending on the efficiency of the solar panels 12. In this example the Chevy Volt has fourteen usable kilowatt hours when fully charged and a full charge takes approximately thirteen hours. In the worst case two kilowatts maybe saved by the solar panels 12 which would result in approximately twelve kilowatts required for a full charge, wherein the time needed for a full charge would be reduced from approximately thirteen hours to eleven hours. Reducing the charge time may also reduce the burden on the electric grid to which the electric vehicle is plugged in for its recharging.

In another example, the solar panels 12 may be retrofitted onto an all gas vehicle, such as a Ford Mercury Crown Victoria. In this example, the hood, roof, trunk, front quarter panels, the front driver door and the rear doors of the vehicle may have a total surface area of approximately 14,800 square inches. Hence, the Ford Mercury in this example may need approximately six solar panels to produce approximately 1,860 watts. As noted in the figures, the solar panel efficiency continues to improve each year, wherein the number of panels to create the number of watts for a vehicle 10 may be increased as the efficiency of the solar panels 12 and the technology thereof increase. The solar panels 12 may create electricity via solar irradiance. Solar irradiance is the sunlight interacting with the solar panel modules arranged over the surface area of the vehicle 10. Voltage is created via the solar panels 12 and may be electrically connected to a charge controller 16 arranged within the vehicle 10, wherein that charge controller 16 is connected to a battery pack 18 for the vehicle 10, thus allowing for the batteries 18 to be charged via the energy and electricity created via the solar irradiance captured by the solar panels 12. The battery 18 may then transfer DC electricity to DC loads of the vehicle 10 and/or pass the DC voltage through an inverter 20 arranged within the vehicle 10 and invert that into AC voltage thus providing energy for any of the AC loads of the vehicle 10. As shown in the figures, the efficiency of solar panels 12 has increased from approximately six percent efficiency in 1954 all the way up to 18.7 percent efficiency in 2018 and the efficiency of the solar panels 12 continues to increase every year. Therefore, the use of solar panels 12 arranged on the entire outside surface of the vehicle 10 may reduce the overall charging time of the battery pack 18 of the vehicle 10 and also help to maintain that charge or even increase that charge while the vehicle 10 is being operated in a sunny outdoor location. It should be noted that the solar panels 12 may be used as the only component to help charge the battery 18 of the vehicle 10 according to the present invention.

Another aspect of the electric solar windmill vehicle 10 of the present invention is that a windmill or windmill turbine 14 may be arranged on an outer surface of the vehicle 10 according to the present invention. In an example, one of the OEM manufacturers, such as Ford, GM, Chrysler, etc., may select a vehicle such as a Chevy Volt and mount a wind turbine 14 on a top surface of the trunk. In one embodiment, it is arranged on a top center surface of the trunk. However, it should be noted that the wind turbine 14 may be arranged anywhere on an outer surface of the vehicle 10, but preferably on the top center of the back of the trunk or the top center of the top of the vehicle 10. It should be noted that generally the windmill 14 may have a predetermined weight with a predetermined size blade, but in one embodiment the weight may be approximately twenty two pounds and the blades may have a sweep of approximately thirty inches, which in turn may create an electrical output of approximately 8000 watts at approximately forty three miles per hour. Therefore, if the Chevy Volt in this example used both the solar panels 12 and the wind turbine 14 thereon, in one scenario, may only require approximately four kilowatts and approximately 3.7 hours from the grid to fully charge because the approximately 8000 watts from the wind turbine 14, combined with the approximately two kilowatts from the solar panels 12 would reduce the kilowatts required from the grid for a full charge to occur. Thus, only approximately four kilowatts and approximately 3.7 hours would be necessary from the grid. It should be noted that any type of methodology may be used to mount the windmill turbine 14 on the trunk or other surface of the vehicle 10, such as but not limited to welding, metal forming, mechanical connections such as bolts, screws, etc., or chemical connecting means such as glues, epoxies, etc. The windmill turbine 14 may also be connected to the battery pack 18 via a charge controller 16 arranged within the vehicle 10. It should be further noted that the windmill turbine 14 may be used exclusively as a stand alone option on a vehicle 10, thus increasing the charging of the battery pack 18 by approximately 8,000 watts on its own, but when used in combination with the solar panels 12 they may reduce the amount for a full charge by approximately ten kilowatts, thus reducing the charge time to 3.7 hours approximately for the example of a Chevy Volt. The windmill 14 only version would reduce the charging time from a Chevy Volt to approximately five hours, thus also reducing the amount of time necessary for the vehicle 10 to be plugged into the electric grid, thus reducing stress on such electric grids. It should further be noted that the windmill turbine 14 may also include a cage surrounding the wind turbine blades in order to protect birds, children, small animals, or other projectiles from being injured from the spinning blades of the turbine 14. It should further be noted that in the example described above, a thirty inch blade sweep is used to generate the approximately 8,000 watts, however any other size blade sweep may be used from approximately one inch to forty eight inches. It should also be noted that a plurality of wind turbines 14 may also be connected to the vehicle 10 in order to increase the amount of charging to the battery pack 18 of the vehicle 10. It should be noted that the wind turbine 14 may be made of any known material, such as but not limited to metal, plastic, composites, natural materials, man made materials, or any other known material capable of withstanding the speeds at which vehicles 10 are driven.

Therefore, when the invention is used on a vehicle 10 that has both the solar panels 12 and the windmill 14 the driving distance of the vehicle 10 may increase. Therefore, the battery pack 18 may be constantly charged and may increase the range of the vehicle 10. It should be noted that generally the wind electric turbine 14 and the solar panels 12 may be electrically connected to the battery pack 18 of the vehicle 10. It should be noted that the battery pack 18 of the vehicle 10 is electrically connected to an electric traction motor 22 of the vehicle 10. This allows for voltage to be provided to the electric traction motor 22 in order to move the vehicle 10 upon pressing of a gas pedal by the driver of the vehicle 10. The vehicle 10 of the present invention also may include a power electric controller 24, which controls all power systems and electrical systems of the vehicle 10. The vehicle 10 also may include a transmission 20 which takes the power from the electric traction motor 22 and transfers it to either two wheels 26 or all wheels of the vehicle 10. The vehicle 10 may also include an onboard charger 28, and a DC to DC converter 30 for use in charging the battery pack 18 of the vehicle 10 and for converting voltage between AC to DC to the necessary voltage for the components of the vehicle 10. It should also be noted that the vehicle 10 may also include a thermal system 32 for cooling the vehicle 10 and an optional auxiliary battery 34 for use in powering systems that need voltage constantly when the electric vehicle battery pack 18 is being charged via the electric grid. All of these components are well known in the art and are not described any further herein. However, all of these components work in conjunction with the unique and novel solar panels 12 and wind electric turbine 14 in order to charge and/or maintain the charge of the battery pack 18 of the vehicle 10 while also reducing the overall charging time necessary on the electric grid. It is also contemplated to have the vehicle charging the battery pack 18 via the solar panels 12 and the blades on the windmill turbine 14 when the vehicle 10 is not driving or moving. Hence, when the vehicle 10 is parked outside and the sun is hitting the solar panels 12 those solar panels 12 may still be charging the battery pack 18 and if the vehicle 10 is parked outside in a windy area the blades on the windmill turbine 14 may still be turning, thus creating and storing energy in the battery pack 18 via the wind. Hence, the solar panels 12 and windmill 14 of the present invention may charge the battery pack 18 when the vehicle 10 is driving and/or not driving. It should be noted that as stated above, either the solar panels 12 may be used as their own on a vehicle 10 or the windmill 14 may be used on its own on the vehicle 10, but it is also contemplated to use the solar panels 12 in conjunction with the windmill 14 to further increase the charging of the battery pack 18 of the vehicle 10, thus reducing the necessary charge time needed from the electric grid. It should be noted that as the vehicle 10 is moving, the turbine blade 14 may be turning and creating energy, if the energy created is greater than what the battery 18 is supplying then the system may turn off the battery power and just use the energy supplied by the windmill 14 via the vehicle speed. As an example to save gas on a 2021 Traverse, the engine turns off at red lights and as soon as the gas pedal is pressed the engine starts up again. The present system is capable of running on any power generated by the sun and/or wind as the vehicle is moving or not moving. Furthermore, if there is excess power it may be stored in the battery pack 18 for later use.

The solar panel 12 and windmill electric system 14 of the present invention may also come with an app 36 for use on a phone or other electronic device. The app 36 may have a logo as shown in the drawings, which shows a vehicle 10 in profile. The app 36 may also show when the battery 18 is being charged via the wind turbine 14 via the solar panels 12. The app 36 may have wind represented by an icon and the sun represented by an icon. The wind icon may turn blue and the sun icon may turn yellow when the vehicle battery pack 18 is being charged via either the wind or the sun, respectively. It should further be noted that in the app 36 the phone may show on a screen the power level 38 to the user or customer of the vehicle 10. This may show how many miles are available to drive or if the gas powered engine needs to be activated if it is an electric hybrid vehicle. The power level app may have a logo with a plurality of lines that may be shaded in a predetermined color, such as red, however any other color may be used which shows a quarter charge equaling approximately twenty five miles, a half charge equaling approximately fifty miles, a three quarter charge equaling approximately seventy five miles, and a full charge equaling approximately one hundred miles corresponding to the number of miles the vehicle can drive on the current charge. It should be noted that the quarter charge, half charge, three quarter charge and full charge estimated mileage may be different depending on the vehicles architecture and the size of the battery pack 18.

The present description is for illustrative purposes only and it should not be construed to limit the present invention in any way. Thus, a person skilled in the art will appreciate that various modifications might be made to the present and disclosed embodiments without departing from the scope and spirit of the present invention, which is defined in terms of the claims below. Other aspects, features and advantages may be apparent upon an examination of the attached drawing figures and appended claims.

What is claimed is:

1. A solar and wind powered vehicle, said vehicle comprising:
a plurality of solar panels arranged on an outside surface of the vehicle; and
a wind turbine mounted to a surface of the vehicle.

2. The vehicle of claim 1 wherein said solar panels are arranged on a door, hood and roof of the vehicle.

3. The vehicle of claim 2 wherein said solar panels are arranged on a trunk of the vehicle.

4. The vehicle of claim 2 wherein said outside surface of the vehicle having a bottom area without said solar panels.

5. The vehicle of claim 4 wherein said bottom area is approximately eight inches.

6. The vehicle of claim 1 further comprising a battery pack arranged in the vehicle, said battery pack is electrically connected to said solar panels and said wind turbine via a charge controller.

7. The vehicle of claim 6 wherein said solar panels and said wind turbine are still producing energy and charging said battery pack when the vehicle is moving or not moving.

8. The vehicle of claim 1 further comprising an onboard charger arranged in the vehicle.

9. The vehicle of claim 1 further comprising a power electric controller arranged in the vehicle.

10. The vehicle of claim 1 further comprising a DC/DC converter arranged in the vehicle.

11. The vehicle of claim 1 further comprising an electric traction motor arranged in the vehicle.

12. The vehicle of claim 1 further comprising a transmission arranged in the vehicle.

13. The vehicle of claim 1 further comprising an auxiliary battery arranged in the vehicle.

14. The vehicle of claim 1 further comprising a thermal system for cooling or heating arranged in the vehicle.

15. The vehicle of claim 1 further comprising an app wirelessly connected to the vehicle, said app monitors status of the charging by said solar panels and said wind turbine.

16. The vehicle of claim 1 wherein the vehicle is all electric or a combination of electric, hybrid or gas.

17. The vehicle of claim 15 wherein said app having an icon representing wind with a blue color and another icon representing sun with a yellow color.

18. The vehicle of claim 1 wherein said wind turbine having a cage thereover or other safety systems.

19. A method of charging a vehicle, said method comprising the steps of:
arranging a plurality of solar panels on an outside surface of the vehicle;
arranging a wind turbine on a surface of the vehicle;
electrically connecting said solar panels and said wind turbine to a battery pack of the vehicle; and
charging said battery pack from wind and sun via said wind turbine and said solar panels.

20. The method of claim 19 wherein said step of charging happens when the vehicle is moving or not moving.
